(19) United States
(12) Patent Application Publication
(10) Pub. No.: US 2022/0388040 A1
(43) Pub. Date: Dec. 8, 2022

(54) EFFERVESCENT CLEANING SYSTEM AND METHOD FOR CLEANING JEWELRY, RETAINERS AND OTHER OBJECTS

(71) Applicant: Rivvin Brands, LLC, Provo, UT (US)

(72) Inventors: Bryan P. DUNFORD, Provo, UT (US); Daniel L. HILL, Provo, UT (US)

(21) Appl. No.: 17/830,896

(22) Filed: Jun. 2, 2022

Related U.S. Application Data
(60) Provisional application No. 63/196,511, filed on Jun. 3, 2021.

(51) Int. Cl. B08B 3/04

(52) U.S. Cl. CPC B08B 3/047

(57) ABSTRACT

Systems and methods for harnessing bubbles generated by an effervescent cleaning tablet, to better clean an object (e.g., jewelry, straw, retainer, dental or orthodontic tray, mouth guard, denture, etc.). The system may include a housing including first and second housing portions, each defining a respective cavity. The first housing portion may be configured to hold the cleaning tablet, while the second cavity may hold or at least attach to the object being cleaned (e.g., hold a ring or other piece of jewelry, a retainer, orthodontic or dental tray, mouth guard, denture, etc.). In the case of a reusable straw, the straw may attach over the second housing cavity. In any case, the bubbles generated by the tablet are forced to flow over the object or surface to be cleaned. Such forced pathway of the bubbles causes them to impart mechanical/kinetic cleansing action to the surface of the object being cleaned.

### CROSS-REFERENCE TO RELATED APPLICATIONS

The present invention claims the benefit under 35 U.S.C. 119(e) of U.S. Application No. 63/196,511, filed Jun. 3, 2021, and entitled EFFERVESCENT CLEANING SYSTEM AND METHOD FOR CLEANING JEWELRY, RETAINERS AND OTHER OBJECTS which is herein incorporated by reference in its entirety.

### BACKGROUND

### Technical Field

This disclosure generally relates to methods and systems for cleaning various objects (e.g., reusable straws, jewelry, dental retainers, mouth guards, dentures, and the like).

### Related Technology

While various methods and systems are available for cleaning various personal objects, such cleaning can be tedious and time consuming. Accordingly, there are a number of disadvantages of existing systems and methods that can be addressed.

### BRIEF SUMMARY

In principle, cleaning occurs when fluid boundaries move across a surface. This is why spraying cleans better than soaking. Similarly, effervescent tablets provide the potential for mechanical cleansing action by moving cleaning agent-laden bubbles across a surface. The mechanical cleansing action results from the passage of bubbles generated by such a dissolvable tablet.

The current state of effervescent tablet cleaning systems is to put an object into a container (e.g., a glass) of water and drop the effervescent tablet in. The effervescent energy and activity dissipates across the relatively large volume of the container, making it relatively ineffective as a mechanical cleaning agent for an object immersed in the container with the tablet.

The present invention provides an improved delivery mechanism for capturing, concentrating, and channeling cleaning solution, and/or cleaning agents in the form of an effervescent tablet, making them more effective in mechanically cleaning an object to be cleaned.

An exemplary embodiment is directed to a cleaning system including a first housing portion defining a first chamber having a volume for receiving an effervescent source which generates bubbles when immersed in water, the first housing portion comprising a fluid conducting inlet on a chamber wall, and a fluid outlet; and a second housing portion defining a second chamber having an inlet and an exit, the inlet being in fluid communication with the first chamber outlet, the inlet and first chamber outlet comprising a unified structure when the first and second housing portions are coupled to one another.

In an embodiment the second housing portion comprises a delivery pathway for capturing, concentrating, and channeling effervescent bubbles generated by the effervescent source.

In an embodiment the second housing portion defining the second chamber additionally comprises a hinge or latch for opening the second chamber or selectively uncoupling the second chamber from the first chamber.

In an embodiment the second chamber additionally comprises a cavity, wherein the cavity comprises a shape for receiving an object to be cleaned; and the inlet and exit are arranged to direct fluid and effervescent bubbles from the inlet across the cavity to the exit.

In an embodiment the second chamber comprises an opening for attachment to and fluid communication with a straw to be cleaned.

In an embodiment the first housing portion defining the first chamber comprises a perforated bottom wall to allow intake of water into the first chamber.

In an embodiment the first and second housing portions are made of a material having a density greater than water, so that the device does not float in water, allowing the chambers to remain underwater during use.

In an embodiment the first chamber and the second chamber are physically divided by a perforated divider, preventing a solid effervescent source from moving into the second chamber while allowing generated effervescent bubbles to freely pass from the first chamber to the second chamber.

In an embodiment the effervescent source is a solid tablet.

In an embodiment the system is used to clean a ring or other piece of jewelry.

In an embodiment the system is used to clean a reusable straw.

In an embodiment the system is used to clean a dental or orthodontic retainer, a dental or orthodontic tray, a mouth guard, or a denture.

This summary is provided to introduce a selection of concepts in a simplified form that are further described below in the detailed description. This summary is not necessarily intended to identify key or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the components and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

The appended drawings contain figures of example embodiments to further illustrate and clarify the above and other aspects, advantages and features of the present invention. It will be appreciated that these drawings depict only example embodiments of the invention and are not intended to limit its scope. The invention will be described and explained with additional specificity and detail through the use of the accompanying drawings.

FIGS. 1-3 show an exemplary cleaning system, according to an embodiment of the invention, configured to clean a straw.

FIGS. 4-8 show an exemplary cleaning system, according to an embodiment of the invention, configured to clean a ring or other piece of jewelry.

FIGS. 9-12 show an exemplary cleaning system, according to an embodiment of the invention, configured to clean a dental or orthodontic tray, retainer, or denture.

### DETAILED DESCRIPTION

Before describing various embodiments of the present disclosure in detail, it is to be understood that this disclosure is not limited to the parameters of the particularly exemplified systems and methods, which may, of course vary. Thus, while certain embodiments of the present disclosure will be described in detail, with reference to specific configurations, the descriptions are illustrative and are not to be construed as limiting the scope of the claimed invention. In addition, the terminology used herein is for the purpose of describing the embodiments, and is not necessarily intended to limit the scope of the claimed invention.

### Exemplary Systems and Methods

The cleaning system according to the present invention includes a housing defining a first chamber with intake holes or openings configured to allow water to flow into the first chamber and activate an effervescent tablet positioned therein during use. A second chamber is also provided, that captures the generated effervescent bubbles and channels them into a concentrated release pathway.

The user places an effervescent tablet in the first chamber, then seals the cavity (i.e., first and second chambers), e.g., by attaching a portion of the housing defining the second chamber. The combined chambers are then placed in a volume of water. The water rushes into the combined cavity through the intake holes of the first chamber, activating the effervescent tablet, with its cleaning agent. The bubbles created by the effervescent tablet rush into the only space available—the concentrated pathway. The motion of this passage of bubbles provides an effective mechanical cleaning to the pathway and any objects in the course of the pathway. This concentration of the generated bubbles and their movement along the concentrated pathway is far more effective at providing a mechanical cleaning action as the bubbles move across the surface to be cleaned, as opposed to having the tablet dissolve with the bubbles dissipating ineffectively throughout the entire volume of water (e.g., in a glass, without any concentrated pathway).

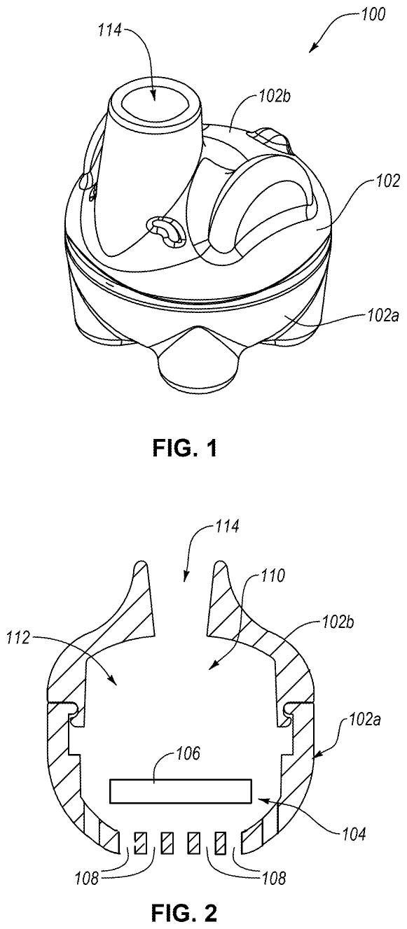

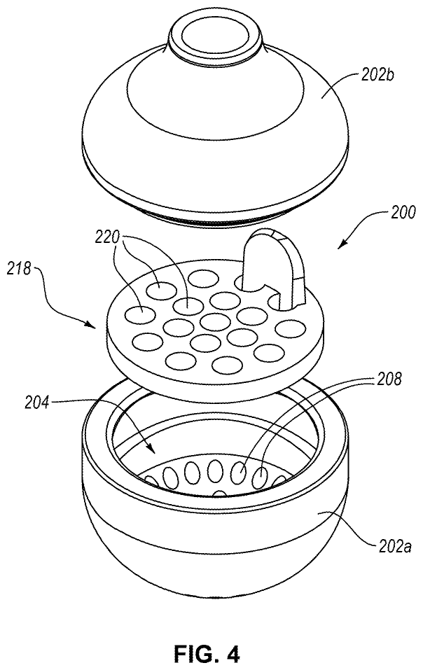

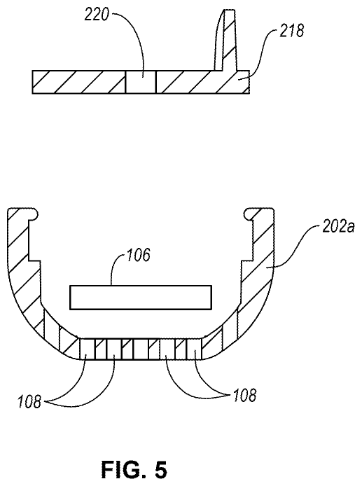

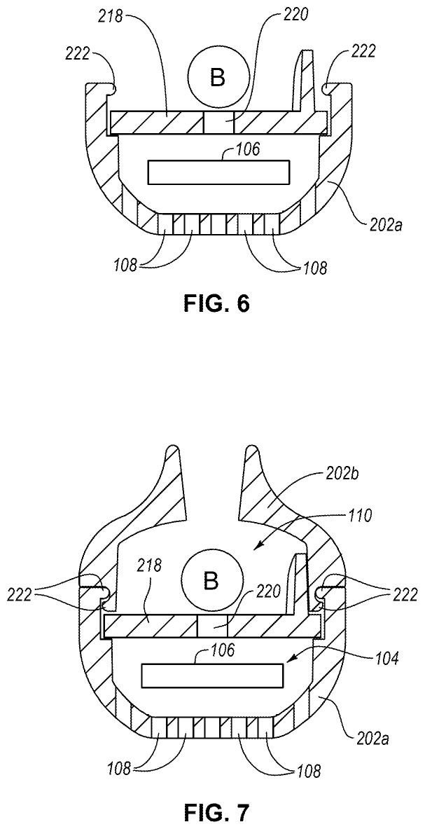

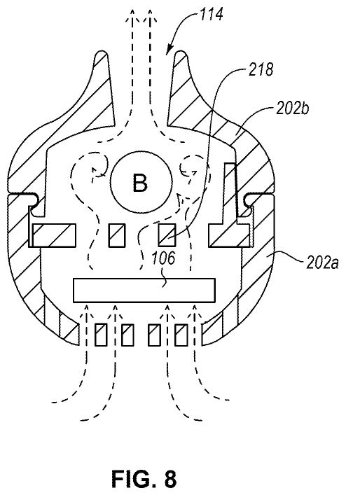

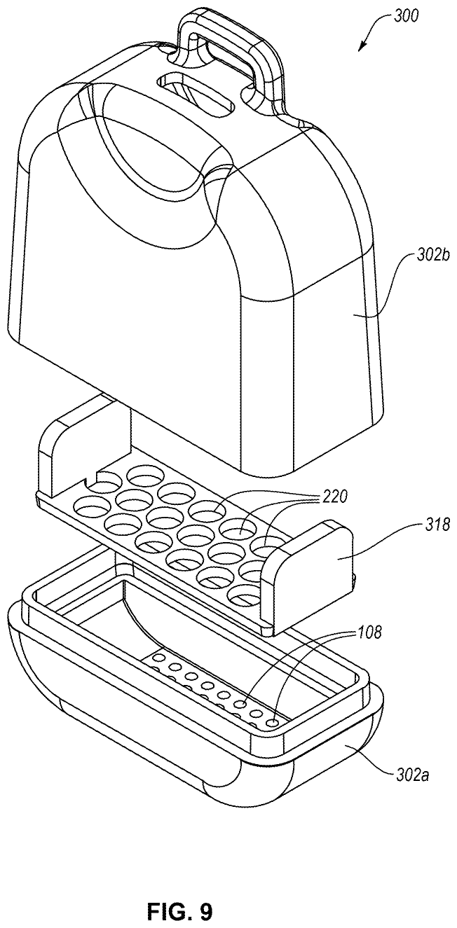

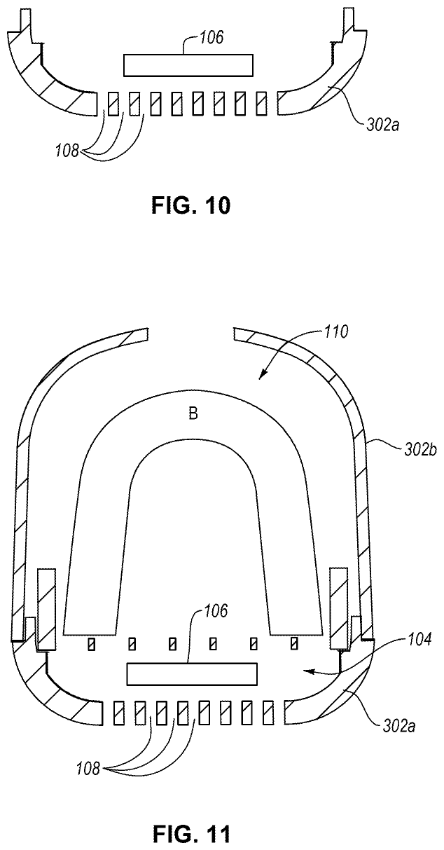

The accompanying Figures illustrate various examples of the present invention, showing an embodiment configured to clean a straw (FIGS. 1-3), an embodiment configured to clean a ring or other piece of jewelry (FIGS. 4-8), and an embodiment configured to clean an orthodontic or dental tray, or orthodontic or dental retainer, mouth guard, denture, etc. (FIGS. 9-12). It will be apparent that numerous other configurations are also possible, to clean any of a wide variety of personal use items that may benefit from periodic cleaning. Provided below are brief descriptions of these exemplary embodiments.

### Straw/Water Bottle Cleaner:

Reusable straws are very difficult to clean, and although one can buy brushes and such for straw cleaning, just placing them in the dishwasher is rarely sufficient to effectively clean a reusable straw. Applicant first made some small tablets to put into the straw, but the water flow was not sufficient to really activate the tablet, and push the bubbles through the straw to achieve effective cleaning. As a result, Applicant developed the chamber concept described herein, which cleans the straw (the bubbles/cleaner effervesce and bubble up through the straw) and the tablet dissolves in the water or water bottle and cleans the water bottle it is in as well.

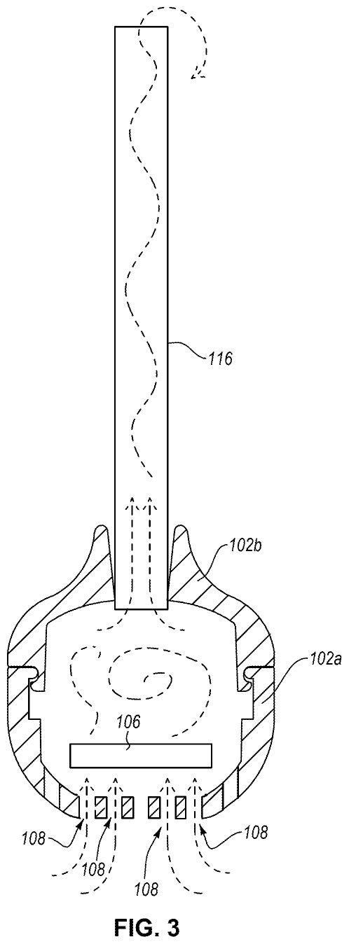

The provisional application referenced above includes screen captures from videos showing the effervescent/bubbling/cleaning action as the bubbles travel up the straw. FIGS. 1-3 provided herewith illustrate an exemplary cleaning device 100. Although the housing 102 of device 100 is in the form of a fanciful “elephant” shape, the housing 102 of course does not have to have this shape, as any animal or other shape could be used. As shown, the housing 102 includes a first housing portion 102a (e.g., a bottom portion) as well as a second housing portion 102b (e.g., a top portion). The first housing portion 102a defines a first chamber 104 having a volume for receiving an effervescent source (e.g., tablet 106) which generates bubbles when immersed in water. The first housing portion 102a includes a fluid conducting inlet on a chamber surface wall (e.g., holes 108 formed in the bottom of the housing portion 102a), as well as a fluid outlet, through which the bubbles enter the second chamber 110 defined by the second housing portion 102b. The second chamber 110 similarly includes an inlet 112, as well as an exit 114. The inlet 112 receives bubbles and fluid from the first chamber outlet, and the inlet 112 and the first chamber outlet can be a unified structure at the interface of the two housing portions 102a, 102b, as shown in FIGS. 2-3. The structure provides a concentrated pathway, where flow of the effervescent bubbles are directed to flow upward, to clean a desired object placed in the pathway. As shown in FIG. 3, the straw 116 connects (e.g., via friction fit) into outlet 114 of the concentrated pathway at the top of the elephant shaped housing 102, channeling the generated bubbles into the straw 116, to clean its interior.

This embodiment for cleaning a straw does not necessarily include a screen or perforated divider between the tablet 106 and the second chamber 110, shown in some of the other embodiments. Several screenshots from videos showing operation of such an embodiment for cleaning a straw are shown in the provisional application, already incorporated by reference.

### Jewelry Cleaner

The provisional application includes screen captures showing attempts to clean a diamond ring, using just a tablet dropped into a glass of water with the ring, without the present inventive system. In such a system all of the scrubbing/cleaning/effervescent force simply dissipates within the container, without really impacting the ring to achieve any significant cleaning action. The cleaning agent in the tablet dissolves in the water, which may have some minimal cleaning value, but none of the mechanical cleaning that could be harnessed from the effervescence is captured, as the effervescent “stream” of bubbles is not directed to pass over and around the object to be cleaned.

FIGS. 4-8 illustrate an exemplary embodiment 200, for use in effervescent cleaning of a piece of jewelry (such as a ring). As shown, device 200 similarly includes a housing, including first and second housing portions 202a and 202b. First housing portion 202a includes holes 108 formed through the bottom wall (i.e., the bottom wall is perforated), as shown, to allow entry of water into the chamber 104 defined by the first housing portion 202a, as in other embodiments. As shown, a perforated divider 218 may be provided between the first and second chambers defined by the two housing portions.

The divider 218 is shown as including a plurality of holes 220 formed therethrough. While such a divider may be optional, it does aid in providing a support on which the ring, other jewelry, or other object to be cleaned can be supported, where the effervescent bubbles can pass up through the holes 220 in divider 218, contacting the object, to achieve the desired cleaning action. As shown, the tablet 106 can reside in the lower chamber 104 defined by first housing portion, while the ring or other object being cleaned can reside in the upper chamber 110 defined by the second housing portion. Because the ring (labeled B) or other object being cleaned is contained within the relatively small chamber 110 (far smaller than the overall glass of water that the device is immersed in), the generated effervescent bubbles are concentrated within a pathway that forces them to rush over the surface of the object being cleaned, resulting in more effective cleaning than simply dropping both the ring and tablet in a glass of water.

As shown, the second housing portion 202b may be selectively coupleable to the first housing portion 202a. The illustrated configuration is shown as including a snap coupling 222, allowing the top housing portion 202b to snap in place over the lower housing portion 202a. The illustrated configuration is simply one possible latch connection that could be used to couple the two housing portions to one another. It will be appreciated that a variety of other hinges or latch mechanisms could alternatively be used, to allow selectively opening or uncoupling of the second chamber 110 from the first chamber 104.

Variations are of course possible. For example, feet and or a small handle could be provided, such as feet to aid in supporting the device on a countertop or other surface, or a handle for attachment to a desired device (e.g., a backpack or the like), or to provide a handle for picking up the device. Another variation may include holes in the sides of the top of the vessel, e.g., to allow a loop or keychain to pass through to allow a chain or string to be attached to lower and raise the device in the water. Such features could be used with any of the devices described herein.

### Retainer Cleaner

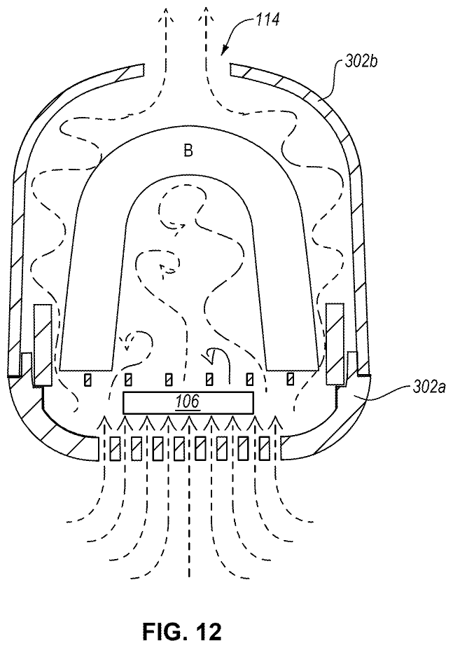

Retainers, dentures, dental or orthodontic trays (e.g., INVISALIGN or a bleaching tray) are also difficult products to clean. Although there are tablets on the market today (EFFERDENT, etc.), these tablets simply dissolve in the water and cause the cleaning agent and cleaning solution to be spread throughout, but no such products really take advantage of the bubbling/scouring/scrubbing action that could be harnessed during dissolution of the tablet, by directed movement of the generated bubbles themselves. FIGS. 9-12 illustrate a device 300 that doubles as a case or housing for storing such a retainer, denture or tray, while also doubling as a cleaning vessel, as described herein. Such a device is similar to those already described, including a first housing portion 302a, a second housing portion 302b, and a perforated divider 318. As described with the other embodiments, the first housing portion 302a defines a first cavity 104, and second housing portion 302b defines a second cavity 110, where such cavities are separated by the perforated divider 318, which includes holes 220 formed therethrough, to allow the generated effervescent bubbles generated from tablet 106 in the first cavity 104 to enter the second cavity 110, passing over and cleaning the retainer, denture tray, or similar device B, as shown in FIG. 12. The tablet 106 goes in the bottom chamber 104 of the housing, the retainer or similar device B to be cleaned goes in the top chamber 110 (e.g., supported on perforated divider 318), and the device 300 is dropped vertically into the water. The tablet 106 dissolves and the bubbles/effervescent energy gets focused inside the chamber 110, like a dishwasher, cleaning object B, and then passes through the opening 114 at the top. Again, such configurations provide the benefit of the tablet 106 dissolving in the solution plus the benefit of physical/kinetic/mechanical cleaning activity from the bubbles and water flow over the surfaces being cleaned, to provide a more effective cleaning or scouring than occurs by simply dropping object B and the effervescent tablet into a glass of water together.

The illustrated configuration is shown as including a loop at the top, allowing the device to be easily clipped (e.g., for storage, attachment to a backpack or the like). Tabs may be provided to help separate/open the separate portions from one another. Such features could be included with any of the embodiments described herein.

In an embodiment, any of the devices as described herein may be formed from a material with a density greater than that of water, to ensure that the device sinks, rather than floating on the surface, having to be held down for immersion to occur. For example, at least some silicones have a density greater than 1 g/cm³, so that they will readily sink when placed in a glass of water. Various typical polyethylenes and polypropylenes may have a density that is less than 1 g/cm³, so as to not be suitable for such purpose, unless they are filled (e.g., with calcium carbonate, or other dense filler), increasing their density to a value of greater than 1 g/cm³.

The provisional application includes screenshots from videos, showing how dental or orthodontic trays cleaned using an embodiment like that shown in FIGS. 9-12 provides effective cleaning of such a tray.

Any headings used herein are for organizational purposes only and are not meant to be used to limit the scope of the description or the claims.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” “involves,” “contains,” etc.), and similar terms as used herein, including within the claims, shall be inclusive and/or open-ended, shall have the same meaning as the word “comprising” and variants thereof (e.g., “comprise” and “comprises”), and do not exclude additional un-recited elements or method steps, illustratively. Unless defined otherwise, all technical and scientific terms used herein have the same meaning as commonly understood by one of ordinary skill in the art to which the present disclosure pertains.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used herein, the term “between” includes any referenced endpoints. For example, “between 2 and 10” includes both 2 and 10.

Disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure. Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Accordingly, the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A cleaning system comprising:
a first housing portion defining a first chamber having a volume for receiving an effervescent source which generates bubbles when immersed in water, the first housing portion comprising a fluid conducting inlet on a chamber wall, and a fluid outlet; and
a second housing portion defining a second chamber having an inlet and an exit, the inlet being in fluid communication with the first chamber outlet, the inlet and first chamber outlet comprising a unified structure when the first and second housing portions are coupled to one another.

2. The system as in claim 1, wherein the second housing portion comprises a delivery pathway for capturing, concentrating, and channeling effervescent bubbles generated by the effervescent source.

3. The system as in claim 1, wherein the second housing portion defining the second chamber additionally comprises a hinge or latch for opening the second chamber or selectively uncoupling the second chamber from the first chamber.

4. The system as in claim 1, wherein the second chamber additionally comprises a cavity, wherein:
the cavity comprises a shape for receiving an object to be cleaned; and
the inlet and exit are arranged to direct fluid and effervescent bubbles from the inlet across the cavity to the exit.

5. The system as in claim 1, wherein the second chamber comprises an opening for attachment to and fluid communication with a straw to be cleaned.

6. The system as in claim 1, wherein the first housing portion defining the first chamber comprises a perforated bottom wall to allow intake of water into the first chamber.

7. The system as in claim 1, wherein the first and second housing portions are made of a material having a density greater than water, so that the device does not float in water, allowing the chambers to remain underwater during use.

8. The system as in claim 1, wherein the first chamber and the second chamber are physically divided by a perforated divider, preventing a solid effervescent source from moving into the second chamber while allowing generated effervescent bubbles to freely pass from the first chamber to the second chamber.

9. The system as in claim 1, wherein the effervescent source is a solid tablet.

10. The system as in claim 1, wherein the system is used to clean a ring or other piece of jewelry.

11. The system as in claim 1, wherein the system is used to clean a reusable straw.

12. The system as in claim 1, wherein the system is used to clean a dental or orthodontic retainer, a dental or orthodontic tray, a mouth guard, or a denture.

13. A cleaning system comprising:
a first housing portion defining a first chamber having a volume for receiving an effervescent tablet which generates bubbles when immersed in water, the first housing portion comprising a fluid conducting inlet on a chamber wall, and a fluid outlet; and
a second housing portion defining a second chamber having an inlet and an exit, the inlet being in fluid communication with the first chamber outlet, the inlet and first chamber outlet comprising a unified structure when the first and second housing portions are coupled to one another so as to define a concentrated delivery pathway for capturing, concentrating, and channeling effervescent bubbles generated by the effervescent source so that such bubbles generated in the first chamber are channeled into the second chamber, where they pass over and clean an object placed into the second chamber.

14. The system as in claim 13, wherein the first housing portion defining the first chamber comprises a perforated bottom wall to allow intake of water into the first chamber.

15. The system as in claim 13, wherein the first and second housing portions are made of a material having a density greater than water, so that the device does not float in water, allowing the chambers to remain underwater during use.

16. The system as in claim 13, wherein the first chamber and the second chamber are physically divided by a perforated divider, preventing the effervescent tablet from moving into the second chamber while allowing generated effervescent bubbles to freely pass from the first chamber to the second chamber.

17. The system as in claim 13, wherein the system is used to clean a ring or other piece of jewelry.

18. The system as in claim 13, wherein the system is used to clean a dental or orthodontic retainer, a dental or orthodontic tray, a mouth guard, or a denture.

19. A cleaning system comprising:
a first housing portion defining a first chamber having a volume for receiving an effervescent tablet which generates bubbles when immersed in water, the first housing portion comprising a fluid conducting inlet on a chamber wall in the form of a perforated bottom wall that allows intake of water into the first chamber; and
a second housing portion defining a second chamber having an inlet and an exit, the inlet being in fluid communication with the first chamber outlet, the inlet and first chamber outlet comprising a unified structure when the first and second housing portions are coupled to one another so as to define a concentrated delivery pathway for capturing, concentrating, and channeling effervescent bubbles generated by the effervescent source so that such bubbles generated in the first chamber are channeled into the second chamber, where they pass over and clean an object placed into the second chamber;
wherein the first chamber and the second chamber are physically divided by a perforated divider, preventing the effervescent tablet from moving into the second chamber while allowing generated effervescent bubbles to freely pass from the first chamber to the second chamber, so as to pass over and clean the object placed into the second chamber.

20. The system as in claim 19, wherein the object placed in the second chamber to be cleaned is a ring, another piece of jewelry, a dental or orthodontic retainer, a dental or orthodontic tray, a mouth guard, or a denture.
